(19) United States
(12) Patent Application Publication
(10) Pub. No.: US 2008/0253768 A1
(43) Pub. Date: Oct. 16, 2008

(54) High Bit Rate Packet Generation with High Spectral Efficiency in an Optical Network

(75) Inventors: Jianjun Yu, Princeton, NJ (US); Philip Nan Ji, Princeton, NJ (US); Lei Xu, Princeton, NJ (US); Ting Wang, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC LABORATORIES AMERICA, INC., Princeton, NJ (US)

(21) Appl. No.: 12/060,351

(22) Filed: Apr. 1, 2008

Related U.S. Application Data
(60) Provisional application No. 60/911,301, filed on Apr. 12, 2007.

(51) Int. Cl. H04J 14/00

(52) U.S. Cl. 398/51

(57) ABSTRACT

Optical packets are generated by generating a first optical beam with a first wavelength and a second optical beam with a second optical beam. The first optical beam is modulated with a payload signal and then filtered to reduce the bandwidth of the signal. The second optical beam is modulated with a label signal. The filtered modulated first optical beam and modulated second optical beam are combined to generate a dual-wavelength optical beam.

This application claims the benefit of U.S. Provisional Application No. 60/911,301 filed Apr. 12, 2007, which is incorporated herein by reference.

### BACKGROUND OF THE INVENTION

The present invention relates generally to fiber optic transmission systems, and more particularly to high bit rate packet generation with high spectral efficiency.

Fiber optics is a highly reliable technology for high-speed packet data transmission in telecommunications networks. For core networks, dense wavelength division multiplex (DWDM) systems may provide as many as 40 optical channels with data rates as high as 100 Gbit/sec per optical channel. Higher optical channel density with higher data rates per optical channel are under development. Although fiber optics has been widely deployed for data transport, most networks still use electronic switching. Whenever an incoming optical signal needs to be switched, it is first converted to an incoming electronic signal via an optoelectronic transceiver. The electrical incoming signal is switched by an electronic switch to an outgoing electrical signal. The outgoing electrical signal is then re-converted to an outgoing optical signal via another optoelectronic transceiver. Optoelectronic conversion, which may occur at each switch along a data path, increases switching times. As transport speeds continue to increase, switching speed becomes an important factor in overall end-to-end data transfer rates. One approach to reducing switching time is to switch the optical signals directly.

In addition to high-performance hardware (fast optical switches), efficient transport protocols are required to realize high-speed optical switching. One protocol is optical-label switching (OLS). In this technique, a label is attached to a payload. The label contains optical routing information, and the payload contains the data content (along with any additional overhead below the optical layer). The label, transmitted at a lower bit rate than the payload (for example, the bit rate for the label may be 2.5 Gbit/s), undergoes optoelectronic conversion and the routing information is read by an electronic processor and controller. The high-speed payload does not undergo optoelectronic conversion and is directly switched in the optical layer.

There are various coding schemes for implementing OLS. In serial coding, a fixed bit rate label is attached to the head of the payload, which may be transmitted at a variable bit rate. The label and the payload are separated by an optical guard-band to handle switching latency. The label may also be transmitted in parallel with the payload. Various methods for parallel transmission exist. For example, the label may be transported on a radio-frequency (RF) subcarrier on the same wavelength channel as the payload. As another example, the label may be transported on a different wavelength than the payload. Parallel coding provides the capability for faster and more flexible label switching than serial coding, but interference between the signal transporting the label and the signal transporting the payload may degrade the signals, particularly at high payload data rates. Furthermore, as the density of optical channels increases, the bandwidth of an optical channel decreases. Spectral efficiency (data rate/channel) becomes an issue. What are needed are method and apparatus for generating high bit rate packets in an optical label-switched network. Method and apparatus which have high spectral efficiency are further advantageous.

### BRIEF SUMMARY OF THE INVENTION

Optical packets are generated by generating a first optical beam with a first wavelength and a second optical beam with a second wavelength. The first optical beam is modulated with a payload signal and then filtered to reduce the bandwidth of the signal. The second optical beam is modulated with a label signal. The filtered modulated first optical beam and modulated second optical beam are combined to generate a dual-wavelength optical beam.

In one embodiment, the first optical beam and the second optical beam may be generated from a single laser by the technique of optical carrier suppression and separation. In another embodiment, the first optical beam and the second optical beam may be generated by two independent lasers, and the optical beams are transmitted through wavelength locks to provide stable wavelengths.

In one embodiment, the payload signal is encoded in a RZ-DQPSK (return-to-zero differential quadrature phase shift key) format, and is filtered with a vestigial sideband filter, such as an optical interleaver, to reduce the bandwidth and improve the spectral efficiency.

These and other advantages of the invention will be apparent to those of ordinary skill in the art by reference to the following detailed description and the accompanying drawings.

### BRIEF DESCRIPTION OF THE DRAWINGS

FIG. 1(a) shows a high-level schematic of a system for generating a payload and a label using optical carrier suppression and separation;

FIG. 1(b) shows a schematic of a technique for intensity modulation of a laser beam;

FIG. 2(a) shows a schematic representation of the spectral distribution of laser beams at various stages during generation of a payload and a label;

FIG. 2(b) shows a measured spectrum of the multiplexed payload and label;

FIG. 3(a) shows a high-level schematic of an of a system for generating and transmitting high bit rate packets with high spectral efficiency using an optical carrier suppression and separation technique;

FIG. 3(b) shows a high-level schematic of a payload generator;

FIG. 3(c) shows a high-level schematic of an of a system for generating and transmitting high bit rate packets with high spectral efficiency using a dual-wavelength lock technique;

FIG. 4(a) and FIG. 4(b) compare the spectrum of a payload before and after vestigial sideband filtering, respectively; and

FIG. 5 shows a flowchart of steps for generating and transmitting high bit rate packets with high spectral efficiency.

### DETAILED DESCRIPTION

Efficient transport protocols are required to realize high-speed optical switching. One protocol is optical-label switching (OLS). In this technique, a label is attached to a payload. The label contains optical routing information, and the payload contains the data content (along with any additional overhead below the optical layer). The label, transmitted at a lower bit rate than the payload (for example, the bit rate for the label may be 2.5 Gbit/s), undergoes optoelectronic conversion and the routing information is read by an electronic processor and controller. The high-speed payload does not undergo optoelectronic conversion and is directly switched in the optical layer.

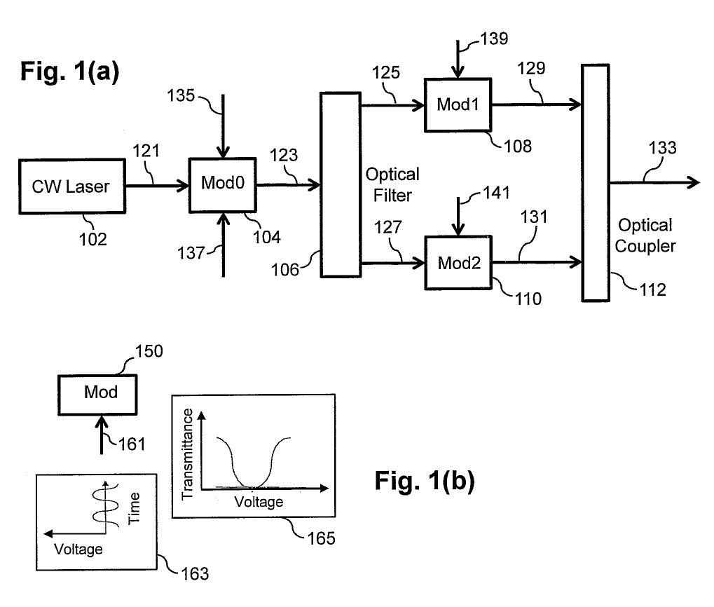

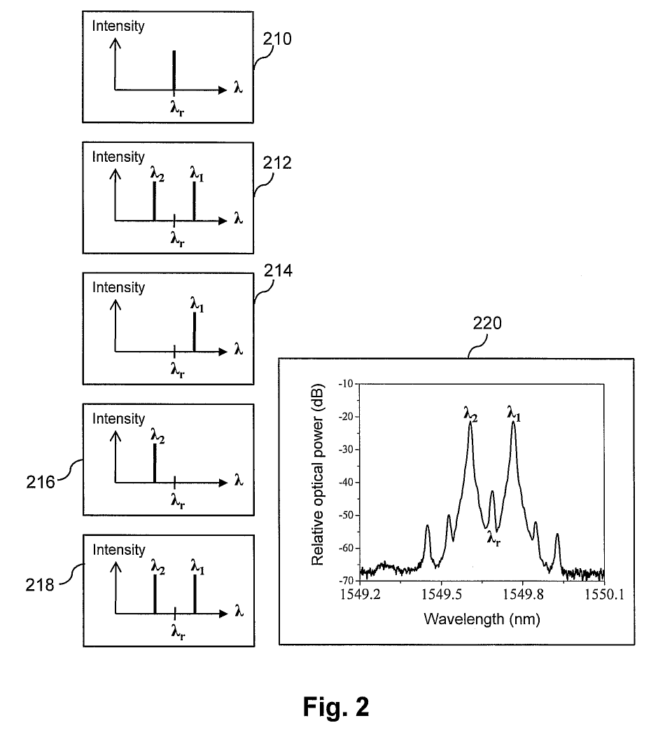

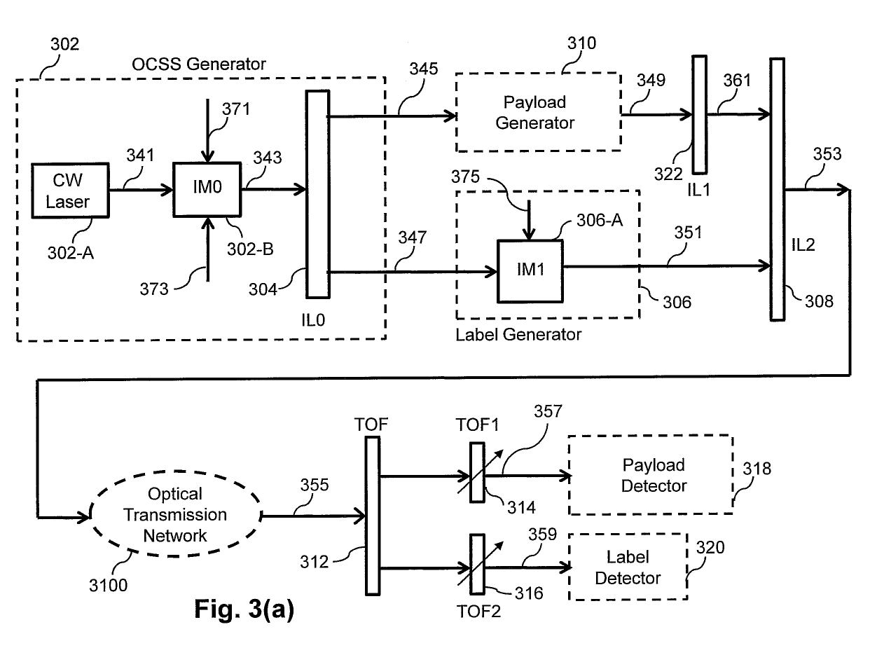

In an embodiment of the invention, the label and payload are generated and transported in parallel using a combination of optical carrier suppression and separation (OCSS) and vestigial sideband filtering processes. FIG. 1(a) shows a high-level schematic of a system for packet generation by OCSS. FIG. 1(b) shows a graphical representation of signal processing by an intensity modulator. FIG. 2 shows graphical representations of optical signals.

In FIG. 1(a), continuous wave (CW) laser 102 emits a constant intensity single-wavelength laser beam 121 with a wavelength λᵣ (called the carrier wavelength). In FIG. 2, the output spectrum (intensity vs. wavelength λ) of laser beam 121 is shown pictorially in plot 210. A measured output spectrum is shown further below. Laser beam 121 is transmitted through intensity modulator Mod0 104, which may, for example, be a dual-arm lithium niobate intensity modulator.

The transmittance of an intensity modulator is a function of an applied electrical drive signal. FIG. 1(b) shows a schematic of the signal processing scheme, using generic Mod 150 and generic RF drive signal 161 as an example. In FIG. 1(b), the voltage of RF drive signal 161 varies sinusoidally with time, as shown in plot 163. When RF drive signal 161 is applied to Mod 150, the transmittance of Mod 150 varies as a function of the voltage applied by RF drive signal 161, as shown in plot 165. One skilled in the art may develop embodiments with other optical sources and modulation schemes. In some applications, for example, a direct modulated laser may be used instead of a CW laser followed by an intensity modulator. In some applications, for example, phase modulation may be used instead of intensity modulation. In the examples below, a laser beam is used to refer to an optical beam. In other examples, however, optical beams may be generated by other optical sources.

Returning to FIG. 1(a), two RF drive signals are applied to Mod0 104. The RF drive signals are generated by an RF generator (not shown in the figure). RF drive signal 135 provides a clock signal with frequency f₀. RF drive signal 137 provides the complementary clock signal at frequency f₀. Input laser beam 121 is transmitted through Mod0 104 and is modulated by RF drive signal 135 and RF drive signal 137. Output laser beam 123 has two wavelengths, λ₁ and λ₂, as shown in output spectrum plot 212. Note that the carrier at wavelength λᵣ is suppressed. Let the frequencies fᵣ, f₁, and f₂ correspond to the wavelengths λᵣ, λ₁, and λ₂, respectively. The relationship of the wavelengths in output laser beam 123 are determined by f₁=fᵣ+f₀ and f₂=fᵣ−f₀.

Dual-wavelength laser beam 123 is then transmitted through optical filter 106, which demultiplexes dual-wavelength laser beam 123 into two single-wavelength beams: laser beam 125 with wavelength λ₁ and laser beam 127 with wavelength λ₂. The output spectrum of laser beam 125 is shown in plot 214. The output spectrum of laser beam 127 is shown in plot 216. Various optical components may be used for optical filter 106. For example, optical filter 106 may be an arrayed waveguide grating. As another example, in an embodiment discussed below, optical filter 106 is an optical interleaver.

Laser beam 125 is transmitted through intensity modulator Mod1 108, which is modulated with RF drive signal 139. RF drive signal 139 carries the encoded payload bit stream. The output laser beam from Mod1 108 is laser beam 129, which maintains an output spectrum at the single wavelength λ₁, as shown in plot 214. Similarly, laser beam 127 is transmitted through intensity modulator Mod2 110, which is modulated with RF drive signal 141. RF drive signal 141 carries the encoded label bit stream. The output laser beam from Mod2 110 is laser beam 131, which maintains an output spectrum at the single wavelength λ₂, as shown in plot 216. In other embodiments, the encoded payload bit stream may be transported on wavelength λ₂, and the encoded label bit stream may be transported on wavelength λ₁.

Laser beam 129 and laser beam 131 are then multiplexed by optical coupler 112 to generate dual-wavelength laser beam 133, which carries both the encoded payload bit stream and the encoded label bit stream. The output spectrum of laser beam 133 is shown in plot 218. Laser beam 133 is then transmitted via an optical fiber to an optical network (not shown). Plot 220 shows a measured output spectrum of laser beam 133. Shown are the signals at λ₁ and λ₂. Note that the carrier signal at λᵣ is suppressed. Various optical components may be used for optical coupler 112. For example, optical coupler 112 may be an arrayed waveguide grating. As another example, in an embodiment discussed below, optical coupler 112 is an optical interleaver.

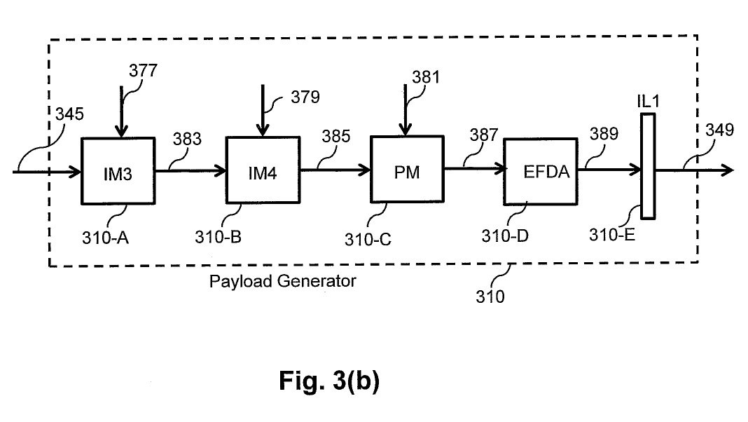

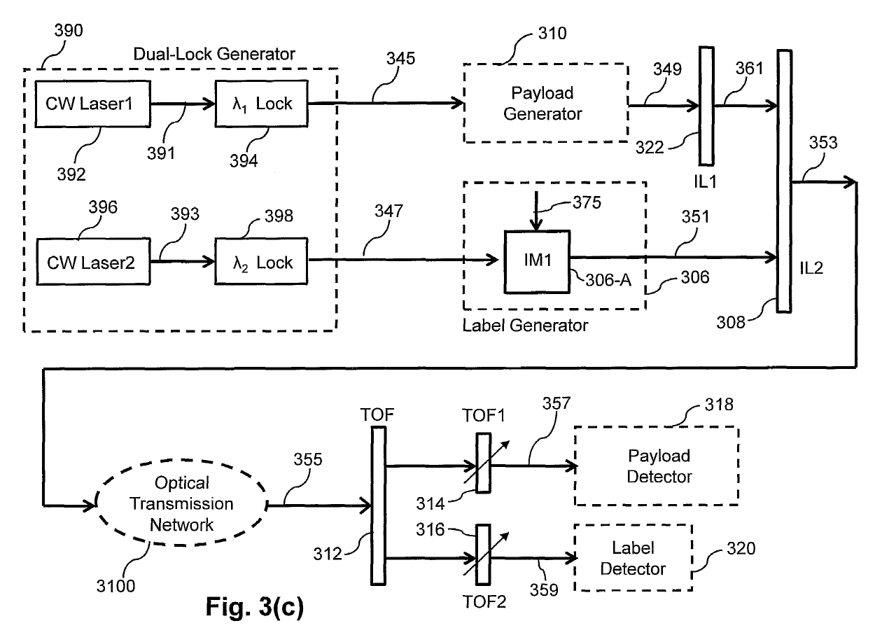

FIG. 3(a) shows a high-level schematic of a system for generating high bit rate optical packets with high spectral efficiency by using a combination of OCSS and vestigial sideband filtering. The system shown in FIG. 3(a) follows the basic architecture shown in FIG. 1(a), except payload generation in FIG. 3(a) is more complex to achieve high bit rate with high spectral efficiency. In FIG. 3(a), OCSS generator 302 is a dual-wavelength optical source which includes CW laser 302-A and intensity modulator IM0 302-B. CW laser 302-A emits laser beam 341 at a single wavelength λᵣ. IM0 302-B is explicitly referred to as an intensity modulator, because phase modulators are also used in this system (discussed below). OCSS generator 302 further includes RF drive signal 371, which supplies a clock signal at frequency f₀, and RF drive signal 373, which supplies a complementary clock signal at frequency f₀. RF drive signal 371 and RF drive signal 373 modulate the transmittance of IM0 302-B. RF drive signal 371 and RF drive signal 373 are generated by an RF generator (not shown in the figure).

The output laser beam from IM0 302-B is dual-wavelength laser beam 343, with wavelengths at λ₁ and λ₂. The relationships between λᵣ, λ₁, λ₂and f₀ was discussed above with reference to the system shown in FIG. 1(a). Laser beam 343 is transmitted through an optical filter, which, in this example, is optical interleaver IL0 304. Optical interleaver IL0 304 demultiplexes dual-wavelength laser beam 343 into its two single-wavelength components. Laser beam 345, at wavelength λ₁, is transmitted to payload generator 310, details of which are discussed below. The output of payload generator 310 is laser beam 349, at wavelength λ₁. Laser beam 349 is transmitted through optical interleaver IL1 322 to perform vestigial sideband filtering, details of which are discussed below. The filtered beam is laser beam 361, at wavelength λ₁.

Laser beam 347, at wavelength λ₂, is transmitted to label generator 306, which has the same configuration used in the example previously shown in FIG. 1(a). Label generator 306 includes intensity modulator IM1 306-A and RF drive signal 375, which carries the encoded label bit stream. The output laser beam from label generator 306 is laser beam 351, at wavelength λ₂. Laser beam 361, carrying the encoded payload bit stream at wavelength λ₁, and laser beam 351, carrying the encoded label bit stream at wavelength λ₂, are transmitted to an optical coupler, which, in this example, is optical interleaver IL2 308. The output of IL2 308 is dual-wavelength laser beam 353, which carries both the encoded payload bit stream at wavelength λ₁ and the encoded label bit stream at wavelength λ₂. Laser beam 353 is transmitted through an optical fiber to optical transmission network 3100.

Details of payload generator 310 are shown in FIG. 3(b). Laser beam 345 is transmitted through a sequence of four optical components: intensity modulator IM2 310-A, intensity modulator IM3 310-B, phase modulator PM 310-C, and erbium doped fiber amplifier EDFA 310-D. Intensity modulator IM2 310-A is driven by RF drive signal 377. Intensity modulator IM3 310-B is driven by RF drive signal 379. Phase modulator PM 310-C is driven by RF drive signal 381. The corresponding optical signals are carried on the following laser beams: laser beam 345 (see FIG. 3(a)) is the input to IM2 310-A; laser beam 383 is outputted from IM2 310-A and inputted to IM3 310-B; laser beam 385 is outputted from IM3 310-B and inputted to PM 310-C; laser beam 387 is outputted from PM 310-C and inputted to EDFA 310-D; and laser beam 389, outputted from EDFA 310-D, is the output of payload generator 310 (see FIG. 3(a)).

In one embodiment, a 100 Gbit/s payload is generated by using a RZ-DQPSK (return-to-zero differential quadrature phase-shift key) modulation format technique. A 50 GHz sinusoidal wave is used for RF drive signal 377 to modulate IM2 310-A to generate RZ-shape pulses on an optical signal carried on laser beam 383. Intensity modulator IM3 310-B is biased at V_{π} (5 volts, in this example) and driven by RF drive signal 379, (10-volt 50 Gbit/s signal, in this example), to generate a phase shift of π on an optical signal carried on laser beam 385. The optical signal is then processed by phase modulator PM 310-C (V_{π}=4 V, in this example) with a phase shift of π/2. RF drive signal 381 is another 50 Gbit/s signal. RF drive signal 379 carries the data 1 (data, I) bit stream. RF drive signal 381 carries the data 2 (data bar, Q) bit stream. In this example, RF drive signal 379 and RF drive signal 381 are generated by multiplexing four 12.5 Gbit/s PRBS signals with a word length of 2⁷−1 or longer word length using an electrical 4:1 multiplexer. There is over 100 bits delay between the bit stream I and the bit stream Q, and the duty cycle of the RZ-QPSK is 50%. With this process, a 100 Gbit/s RZ-DQPSK payload is generated.

Laser beam 387 is amplified by EDFA 310-D. The amplified beam, laser beam 349, is then outputted from payload generator 310. Returning to FIG. 3(a), laser beam 349 is transmitted through optical interleaver IL1 322 for vestigial sideband filtering for the 100 Gbit/s DQPSK payload. In this example, the central wavelength for IL1 322 is 0.2 nm away from the standard wavelength defined by the ITU-T standards.

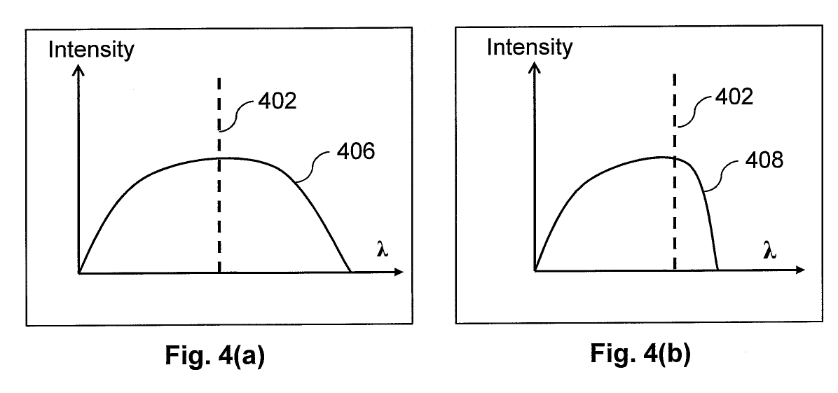

The optical spectrum of the regular modulation format is a double sideband. The signals at both sides of the optical carrier are identical. In principle, one sideband may be removed, and the signal quality may be maintained. If the filter to remove a sideband is not perfect, however, the signal quality may be degraded. Signal degradation may be reduced by using an optical filter for vestigial sideband filtering. The spectrum for laser beam 349 at the input of IL1 322 and the spectrum for laser beam 361 at the output of IL1 322 are shown in FIG. 4(a) and FIG. 4(b), respectively. Marker 402 indicates the wavelength of the optical carrier. In FIG. 4(a), the output spectrum 406 before vestigial sideband filtering is symmetric about the optical carrier. In FIG. 4(b), the output spectrum 408 after vestigial sideband filtering is asymmetric. The intensity at longer wavelengths has been reduced. Vestigial sideband filtering decreases the spectral distribution, and thus increases spectral efficiency.

Returning to label generator 306, in one embodiment the label is generated by a on/off keying (OOK) modulation format technique. The label is generated by driving IM1 306-A with RF drive signal 375, which is a 2³¹−1 pseudo-random bit sequence (PRBS) electrical signal with a data rate of 3.125 Gbit/s. The encoded label bit stream is carried on laser beam 351. Laser beam 361 and laser beam 351 are then multiplexed by optical interleaver IL2 308. Optical interleaver IL2 308 is a 100/200 GHz optical interleaver with ITU-T standard central wavelength. Transmission of the combined signal through IL2 308 ensures that the combined signal occupies only 100 GHz bandwidth. The output of IL2 308 is laser beam 353, which is transmitted to optical transmission network 3100.

Laser beam 355 is the output laser beam from optical transmission network 3100. The payload and label are then demultiplexed. Laser beam 355 is transmitted into tunable optical filter array TOF 312. Tunable optical filter TOF1 314 transmits laser beam 357 with wavelength λ₁. Laser beam 357 is transmitted to payload detector 318, details of which are not shown. Tunable optical filter TOF2 316 transmits laser beam 359 with wavelength λ₂. Laser beam 359 is transmitted to label detector 320, details of which are not shown. In an embodiment, a payload data rate of 100 Gbit/s may be generated with a spectral efficiency of 1 bit/Hz/s.

FIG. 3(c) shows another embodiment of the invention. In place of OCSS Generator 302 in FIG. 3(a), the dual-wavelength optical source is dual wavelength-lock generator 390. CW laser1 392 emits laser beam 391 with wavelength λ₁. To stabilize the wavelength, laser beam 391 is transmitted through λ₁ wavelength-lock 394. The output of λ₁ wavelength-lock 394 is laser beam 345, which is inputted to payload generator 310 (same as in FIG. 3(a)). Similarly, CW laser2 396 emits laser beam 393 with wavelength λ₂. To stabilize the wavelength, laser beam 393 is transmitted through λ₂ wavelength-lock 398. The output of λ₂ wavelength-lock 398 is laser beam 347, which is inputted to label generator 306 (same as in FIG. 3(a)). The function of wavelength locking is usually realized by a narrow-band filter along with a power monitor. The generated electrical signal from the power monitor is used as feedback to control the temperature of the laser.

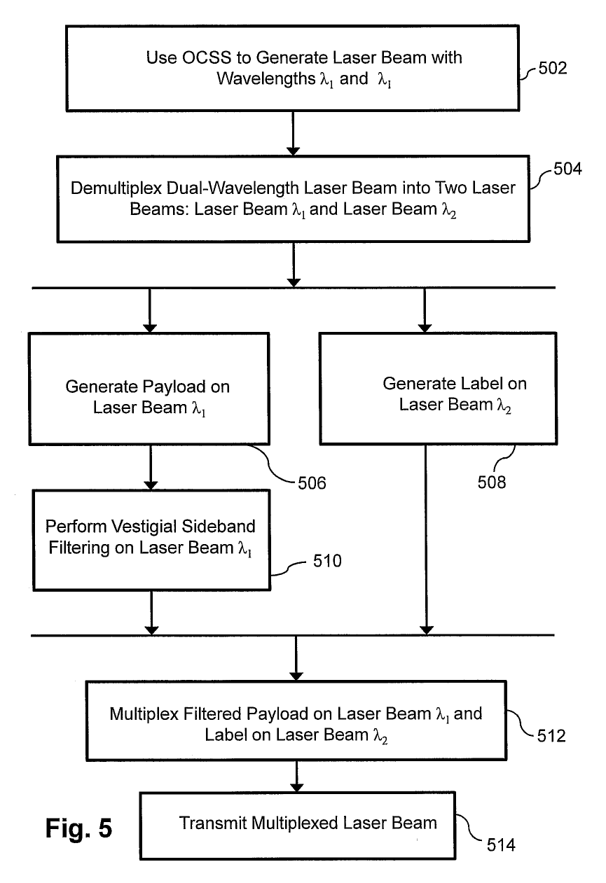

The flowchart in FIG. 5 summarizes the steps for generating and transmitting a high bit rate optical packet with high spectral efficiency, according to an embodiment of the invention using an OCSS technique. In step 502, a dual-wavelength laser beam with wavelengths λ₁ and λ₂ is generated by OCSS generator 302. In step 504 the dual-wavelength laser beam is demultiplexed by optical interleaver IL0 304 into two single-wavelength laser beams: laser beam λ₁ and laser beam λ₁. In step 506, the payload is generated by payload generator 310 and encoded on laser beam λ₁. In step 510, the payload is filtered by optical interleaver IL1 322. In step 508, the label is generated by label generator 306 and encoded on laser beam λ₂. In step 512, the label and the filtered payload are multiplexed into a dual-wavelength laser beam by optical interleaver IL2 308. In step 514, the multiplexed laser beam is transmitted via an optical fiber to optical transmission network 3100.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method for generating optical packets, comprising the steps of:
generating a first optical beam having a first wavelength and a second optical beam having a second wavelength;
modulating said first optical beam with a payload signal;
filtering said modulated first optical beam;
modulating said second optical beam with a label signal; and
combining said filtered modulated first optical beam and said modulated second optical beam.

2. The method of claim 1, wherein said step of filtering said modulated first optical beam further comprises the step of:
filtering said modulated first optical beam with a vestigial sideband filter.

3. The method of claim 2, wherein said vestigial sideband filter comprises an optical interleaver.

4. The method of claim 1, wherein said step of generating a first optical beam having a first wavelength and a second optical beam having a second wavelength, further comprises the step of:
generating said first optical beam having said first wavelength and said second optical beam having said second wavelength by optical carrier suppression and separation of a third optical beam having a third wavelength.

5. The method of claim 1, wherein said step of generating a first optical beam having a first wavelength and a second optical beam having a second wavelength, further comprises the steps of:
generating said first optical beam having said first wavelength and transmitting said first optical beam through a first wavelength lock; and
generating said second optical beam having said second wavelength and transmitting said second optical beam through a second wavelength lock.

6. The method of claim 1, wherein said step of modulating said first optical beam with a payload signal further comprises the step of:
modulating said first optical beam with a return-to-zero differential quadrature phase shift key (RZ-DQPSK) payload signal.

7. The method of claim 1, wherein said step of modulating said second optical beam with a label signal further comprises the step of:
modulating said second optical beam with a on/off key (OOK) label signal.

8. The method of claim 1, wherein said step of combining said filtered modulated first optical beam and said modulated second optical beam further comprises the step of:
combining said filtered modulated first optical beam and said modulated second optical beam with an optical interleaver.

9. An apparatus for generating optical packets, comprising:
means for generating a first optical beam having a first wavelength and a second optical beam having a second wavelength;
means for modulating said first optical beam with a payload signal;
means for filtering said modulated first optical beam;
means for modulating said second optical beam with a label signal; and
means for combining said modulated first optical beam and said modulated second optical beam.

10. The apparatus of claim 9, further comprising:
means for filtering said modulated first optical beam with a vestigial sideband filter.

11. The apparatus of claim 10, wherein said vestigial sideband filter is an optical interleaver.

12. The apparatus of claim 9, further comprising:
means for generating said first optical beam having said first wavelength and said second optical beam having said second wavelength by optical carrier suppression and separation of a third optical beam having a third wavelength.

13. The apparatus of claim 9, further comprising:
means for generating said first optical beam having said first wavelength and transmitting said first optical beam through a first wavelength lock; and
means for generating said second optical beam having a second wavelength and transmitting said second optical beam through a second wavelength lock.

14. The apparatus of claim 9, further comprising:
means for modulating said first optical beam with a RZ-DQPSK payload signal.

15. The apparatus of claim 9, further comprising:
means for modulating said second optical beam with a OOK label signal.

16. The apparatus of claim 9, further comprising:
means for combining said filtered modulated first optical beam and said modulated second optical beam with an optical interleaver.

17. An apparatus for generating optical packets, comprising:
a dual-wavelength optical source generating a first optical beam having a first wavelength and a second optical beam having a second wavelength;
a payload generator for encoding said first optical beam with a payload signal;
a filter for filtering said encoded first optical beam;
a label generator for encoding said second optical beam with a label signal; and
an optical coupler for combining said filtered encoded first optical beam and said encoded second optical beam.

18. The apparatus of claim 17, wherein said filter is a vestigial sideband filter.

19. The apparatus of claim 18, wherein said vestigial sideband filter is an optical interleaver.

20. The apparatus of claim 17, wherein said dual-wavelength optical source is an optical carrier suppression and separation generator comprising:
a continuous wave laser emitting a laser beam at a third wavelength;
an intensity modulator;
a radio-frequency (RF) generator configured to generate a first RF-drive signal with frequency f₀ carrying a clock signal and a second RF drive signal with frequency f₀ carrying the complementary clock signal;
wherein said first RF drive signal and said second RF drive signal are applied to said intensity modulator; and
an optical filter to separate said first laser beam and said second laser beam.

21. The apparatus of claim 17, wherein said dual-wavelength optical source is a dual wavelength-lock generator comprising:
a first continuous wave laser emitting a laser beam at said first wavelength;
a first wavelength lock at said first wavelength;
a second continuous wave laser emitting a laser beam at said second wavelength; and
a second wavelength lock at said second wavelength;

22. The apparatus of claim 17, wherein said payload generator further comprises:
a RZ-DQPSK signal generator.

23. The apparatus of claim 17, wherein said label generator further comprises:
an OOK signal generator.

24. The apparatus of claim 17, wherein said optical coupler further comprises:
an optical interleaver.
